(19) United States
(12) Patent Application Publication
(10) Pub. No.: US 2004/0190391 A1
(43) Pub. Date: Sep. 30, 2004

(54) Message recording unit, message reproducing unit and message recording/reproducing method

(75) Inventor: Naoto Kinjo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/807,196

(22) Filed: Mar. 24, 2004

(30) Foreign Application Priority Data
Mar. 25, 2003 (JP) 2003-083573

(51) Int. Cl. G11B 7/085

(52) U.S. Cl. 369/30.03

(57) ABSTRACT

The message recording unit and method identify an article or specify a predetermined position in a content recording medium, input related information corresponding to the article or the predetermined position and record as message information the article and the related information or position information indicating the predetermined position and the related information or an access destination of the related information in correspondence to each other into a storage. The message reproducing unit and method identify the article or reference the content recording medium, search the storage for the message information corresponding to the article or the predetermined position, and read and output the detected message information. The message recording/reproducing method includes the message recording method and the message reproducing method.

### BACKGROUND OF THE INVENTION

The present invention relates to a message recording unit, a message reproducing unit and a message recording/reproducing method, and in particular to a message recording unit, a message reproducing unit and a message recording/reproducing method whereby, in case a message is input or related information is specified to a content recorded onto a physical recording medium such as a book, notebook or newspaper with a predetermined location in the recording medium specified, the message or related information is automatically regenerated in the predetermined location in the recording medium.

Conventionally, people used to enjoy a content recorded on a recording medium such as a book, notebook or newspaper, or a content delivered over a TV broadcast or radio broadcast in a passive fashion, such as just receiving the content.

An exemplary way of positively enjoying a content recorded on a physical recording medium or a hardware recording medium such as a book, notebook or newspaper is to assign message information to a predetermined page of a book so that the previously assigned message information will be regenerated when the book is opened later to read it again. Another example is to transmit the message information to a friend of the user's so that the message will be regenerated when the friend open the page of the book. Such examples pertain to transmission of message information via a recording medium.

However, there have been no methods for transmitting message information via a recording medium by facilitating assignment (recording) of message information onto a recording medium or reproduction of the message information. The only method has been to directly write a message to a recording medium.

For example, as a method for writing a message to a photo print as a physical recording medium, JP 2001-268342 A discloses a method and a system for regenerating an image with a message where a message from a third party is affixed when shot image data is regenerated as a visible image in order to enhance the photographic entertainment.

To be more specific, the process is as follows: A reference image on which a message is to be written is generated from the image data of a shot image to be regenerated. The reference image is transmitted to a third party such as acquaintances or friends of the user's, who write messages onto the reference image and return it. A photo print is output including the shot image with the messages affixed thereto.

It is desired, however, to establish communications via a recording medium, in utilizing a medium such as a physical recording medium, in order not to just passively enjoy contents, not to record messages in one direction only, but to facilitate message recording and reproduction.

In this respect, the method according to JP 2001-268342 A transmits an image to a third party who will write a message on the image and outputs the image with the message written thereon. This method does not support origination of the user's own message. The method is cumbersome because it takes time to transmit an image to a third party who will write a message on the image.

In case message information cannot be written directly on a recording medium such as a book, notebook or a photo album, the message information is written on a separate sheet of paper or input to a personal computer. The user may study related items in Internet sites while he/she is reading a book.

In such cases, if a location such as a page of the book or the notebook is not associated with the previously written message information when the user reads the book or the notebook again later, it is very cumbersome to regenerate or reference the message information.

### SUMMARY OF THE INVENTION

The invention has been accomplished in view of the prior art problems. An object of the invention is to provide a message recording unit, a message reproducing unit and a message recording/reproducing method which facilitate recording of message information in a content recorded on various articles, in particular a physical recording medium and its reproduction while establishing communications with a third party by using the content in order to enhance the entertainment in contents appreciation.

In order to attain the object described above, a first embodiment of the present invention provides a message recording unit comprising article identification means for acquiring identification information to identify an individual article, related information input means for inputting related information related to the individual article, and message recording means for recording into a storage as a message information the identification information of the individual article and the related information on the individual article in correspondence to each other.

In order to attain the object described above, a second embodiment of the present invention provides a message reproducing unit for regenerating message information recorded into a storage by a message recording unit, the message recording unit comprising first article identification means for acquiring identification information to identify an individual article, related information input means for inputting related information related to the individual article, and message recording means for recording into the storage as the message information the identification information of the individual article and the related information on the individual article in correspondence to each other, the message information regenerating unit comprising second article identification means for acquiring the identification information to identify the individual article, search means for searching the storage for the message information corresponding to the identification information, and message information output means for outputting the message information corresponding to the identification information in case such message information is detected.

In order to attain the object described above, a third embodiment of the present invention provides a message recording unit comprising position information acquisition means for acquiring position information to identify a specific position on an individual article, related information input means for inputting related information related to the specific position on the individual article, and message information recording means for recording into a storage as message information the position information of the specific position on the individual article and the related information on the specific position on the individual article in correspondence to each other.

In order to attain the object described above, a fourth embodiment of the present invention provides a message reproducing unit for regenerating message information recorded into a storage by a message recording unit, the message recording unit comprising first position information acquisition means for acquiring position information to identify a specific position on an individual article, related information input means for inputting related information related to the specific position on the individual article, and message information recording means for recording into the storage as the message information the position information of the specific position on the individual article and the related information on the specific position on the individual article in correspondence to each other, the message regenerating unit comprising second position information acquisition means for acquiring the position information to identify the specific position on the individual article, search means for searching the storage for the message information corresponding to the position information on the specific position on the individual article, and message information output means for outputting the message information corresponding to the position information in case such message information is detected.

In order to attain the object described above, a fifth embodiment of the present invention provides a message recording unit comprising photographing means for photographing a content recording medium to which an integrated circuit tag is affixed, an integrated circuit tag sensor for communicating with the integrated circuit tag affixed to the content recording medium, photography instruction means for receiving a signal to notice detection of the content recording medium from the integrated circuit tag sensor and instructing the photographing means to photograph the content recording medium whose predetermined position is specified, position information recognition means for receiving an image of the content recording medium shot by the photographing means and recognizing position information indicating the specified predetermined position in the content recording medium, related information input means for inputting related information related to the predetermined position in the content recording medium, and message information recording means for recording as message information a combination of the position information and the related information or an access destination of the related information into a storage.

In order to attain the object described above, a sixth embodiment of the present invention provides a message recording unit comprising detection means for detecting a predetermined position on a surface of a content recording medium on the surface of which a predetermined pattern is formed by specifying the predetermined pattern on the content recording medium, position information recognition means for recognizing position information from the predetermined position detected by the detection means, related information input means for inputting related information related to the predetermined position in the content recording medium, and message information recording means for recording as message information a combination of the position information and the related information or an access destination of the related information into a storage.

In order to attain the object described above, a seventh embodiment of the present invention provides a message reproducing unit for regenerating message information recorded into a storage by a message recording unit, the message recording unit comprising first photographing means for photographing a content recording medium to which an integrated circuit tag is affixed, a first integrated circuit tag sensor for communicating with the integrated circuit tag affixed to the content recording medium, first photography instruction means for receiving a signal to notice detection of the content recording medium from the first integrated circuit tag sensor and instructing the first photographing means to photograph the content recording medium whose predetermined position is specified, first position information recognition means for receiving an image of the content recording medium shot by the first photographing means and recognizing position information indicating the specified predetermined position in the content recording medium, related information input means for inputting related information related to the predetermined position in the content recording medium, and message information recording means for recording as the message information a combination of the position information and the related information or an access destination of the related information into the storage, the message information regenerating unit comprising second photographing means for photographing the content recording medium to which the integrated circuit tag is affixed, a second integrated circuit tag sensor for communicating with the integrated circuit tag affixed to the content recording medium, second photography instruction means for receiving the signal to notice detection of the content recording medium from the second integrated circuit tag sensor and instructing the second photographing means to photograph the content recording medium, second position information recognition means for receiving the image of the content recording medium shot by the second photographing means and recognizing the position information on the predetermined position in the content recording medium, search means for searching the storage for the message information corresponding to the predetermined position in the content recording medium, and message information output means for outputting the message information corresponding to the predetermined position in the content recording medium in case such message information is detected.

In order to attain the object described above, a eighth embodiment of the present invention provides a message reproducing unit for regenerating message information recorded into a storage by a message recording unit, the message recording unit comprising first detection means for detecting a predetermined position on a surface of a content recording medium on the surface of which a predetermined pattern is formed by specifying the predetermined pattern on the content recording medium, first position information recognition means for recognizing position information from the predetermined position detected by the first detection means, related information input means for inputting related information related to the predetermined position in the content recording medium, and message information recording means for recording as the message information a combination of the position information and the related information or an access destination of the related information into the storage, the message information regenerating unit comprising second detection means for detecting a predetermined position on the content recording on the surface of which the predetermined pattern is formed by specifying a predetermined pattern on the content recording medium, second position information recognition means for recognizing position information from a predetermined position detected by the second detection means, search means for searching the storage for the message information corresponding to the predetermined position on the content recording medium, and message information output means for outputting the message information corresponding to the predetermined position on the content recording medium in case such message information is detected.

In order to attain the object described above, a ninth embodiment of the present invention provides a message recording/reproducing method, comprising the steps of in a side of a message recording unit, identifying an individual article, inputting related information corresponding to the identified individual article, and recording as message information the article and the related information in correspondence to each other into a storage, and thereafter in a side of a message reproducing unit, identifying the individual article, searching the storage for the message information corresponding to the identified individual article, reading the message information in case the message information is detected, and outputting the read message information.

In order to attain the object described above, a tenth embodiment of the present invention provides a message recording/reproducing method, comprising the steps of in a side of a message recording unit, specifying a predetermined position in a content recording medium, inputting related information corresponding to the predetermined position, and recording as message information position information indicating the predetermined position and the related information or an access destination of the related information in correspondence to each other in a storage, and thereafter in a side of a message reproducing unit, referencing the content recording medium, searching the storage to determine whether the message information corresponding to the predetermined position on the content recording medium is recorded, reading the message information in case the corresponding message information is recorded and outputting the read message information.

Also, in order to attain the object described above, the tenth embodiment of the present invention provides a message recording/reproducing method, comprising the steps of in a side of a message recording unit, specifying a predetermined position in a content recording medium, inputting related information corresponding to the predetermined position, and providing a message reproducing unit with position information indicating the predetermined position and the related information or an access destination of the related information in correspondence to each other as message information, and thereafter in a side of a message reproducing unit, receiving the message information, accumulating the received message information in a storage, referencing the content recording medium, searching the storage to determine whether the message information corresponding to the predetermined position on the content recording medium is accumulated, reading the message information in case the corresponding message information is accumulated, and outputting the read message information.

### BRIEF DESCRIPTION OF THE DRAWINGS

FIG. 1 is a block diagram showing the general configuration of a message recording/reproducing system including both functions of a message recording unit and a message reproducing unit according to a first embodiment of the invention;

FIG. 2 is a flowchart showing the message recording method according to a first embodiment of the invention;

FIG. 3 is a flowchart showing the message reproducing method according to a first embodiment of the invention;

FIG. 4 is a block diagram showing the general configuration of a message recording/reproducing system including both functions of a message recording unit and a message reproducing unit according to a second embodiment of the invention;

FIG. 5 is a flowchart showing the message recording and reproducing methods according to a second embodiment of the invention;

FIG. 6 is a block diagram showing the general configuration of a message recording/reproducing system including both functions of a message recording unit and a message reproducing unit according to a third embodiment of the invention;

FIG. 7 is a flowchart showing the message recording method according to a third embodiment of the invention;

FIG. 8 is a flowchart showing the message reproducing method according to a third embodiment of the invention; and

FIG. 9 is an explanatory drawing of another example of application of the invention.

### DETAILED DESCRIPTION OF THE INVENTION

A message recording unit, a message reproducing unit and a message recording/reproducing method according to the invention are detailed based on the preferred embodiments shown in the attached drawings.

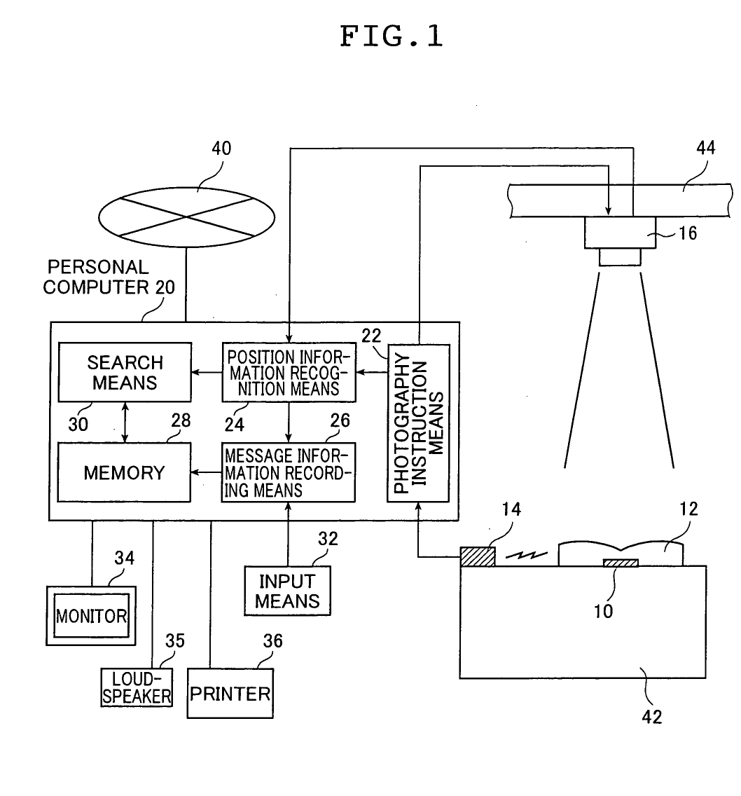

FIG. 1 is a block diagram showing the general configuration of a message recording/reproducing system including both functions of a message recording unit and a message reproducing unit according to a first embodiment of the invention.

As shown in FIG. 1, the message recording/reproducing system mainly comprises a content recording medium 12 (for example a book, hereinafter referred to as the book 12) having an IC tag 10, an IC tag sensor 14 for communicating with the IC tag 10 to detect the book 12, photographing means 16 (for example a digital camera, hereinafter simply referred to as the camera 16) for photographing the book 12, and a personal computer 20 having various functions.

The personal computer 20 comprises photography instruction means 22, position information recognition means 24, message information recording means 26, a memory 28 and search means 30.

To the personal computer 20 are connected input means 32 for inputting message information, and a monitor 34, a loudspeaker 35 or a printer 36 for outputting (regenerating) message information. Further, the personal computer 20 is connected to a network 40 such as the Internet.

The IC tag 10 is affixed to the backbone, front cover or back cover in case the content recording medium is the book 12 as shown. In case the book 12 is placed on a desk 42 as shown in FIG. 1, the IC tag sensor 14 is arranged on the desk 42.

The camera 16 is mounted just above the book 12, on a ceiling 44, at a light such as a fluorescent light or on dedicated fixing means.

The photography instruction means 22, receiving a detection signal for the book 12 from the IC tag sensor 14, issues an instruction to photograph the book 12 to the camera 16. As mentioned above, the camera 16 is arranged just above the book 12 as a content recording medium and photographs the entire page of the book 12 which is then open.

The position information recognition means 24 acquires the image of the book 12 shot with the camera 16 and detects for example a position on a page of the book 12 pointed at by the system user from this shot image to create position information.

In this practice, in case the user points at a predetermined position on a page of the book 12 by using a predetermined instruction tool, it suffices to detect the instruction tool, for example the tip of the tool from the shot image. This is a preferable procedure which allows easy detection of a pointed position.

The message information recording means 26 records onto a memory (storage) 28 the message information as a combination of the related information such as a message corresponding to the position pointed on the book 12 input by the system user from the input means 32 or access destination of the related information and the position information created by the position information recognition means 24. While the memory 28 is an internal memory in the personal computer 20 in the figure, the invention is not limited thereto but may be an external storage.

Note that, in the personal computer 20, the photography instruction means 22, position information recognition means 24, message information recording means 26 and the memory 28 function as a message recording unit.

When regenerating a message, the search means 30 uses the position information acquired from the image of the book 12 mentioned above to search the memory 28 to determine whether message information corresponding to the position information is recorded in the memory 28. In case the message information is present in the memory 28, the search means 30 outputs (regenerates) the message information onto the monitor 34 or the printer 36.

The input means 32 is used by the system user to point at a predetermined position (for example a line of a page of the book) to input related information such as a message related to the position. Examples of the input means 32 include a keyboard for inputting text data, a microphone for inputting audio data, and a scanner for reading and inputting handwritten characters or pictures.

The action of this embodiment is described below referring to flowcharts respectively for message recording and message reproduction.

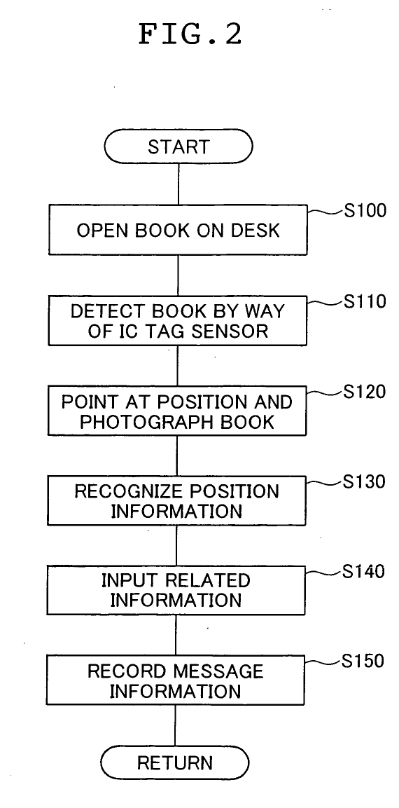

FIG. 2 is a flowchart showing the message recording process in a message recording/reproducing system according to this embodiment.

First, the message recording method is described below referring to FIG. 2.

In step S100 of FIG. 2, the system user places the book (content recording medium) 12 open having the IC tag 10. In step S110, the IC tag sensor 14 arranged on the desk 42 communicates with the IC tag 10 on the book 12 to detect or identify the book 12.

A detection signal is transmitted from the IC tag sensor 14 to the personal computer 20 and input to the photography instruction means 22 and the position information recognition means 24.

Next, in step S120, the system user points at a position on a page of the book 12 and photographs the entire book 12 by using the camera 16 arranged just above the book 12. Photographing is made when the photography instruction means 22 which has received the detection signal for the book 12 from the IC tag sensor 14 issues a photography instruction to the camera 16. The photographing may be automatically performed in succession at predetermined intervals when the photography instruction means 22 receives the detection signal for the book 12. Or the photographing may be performed as the user instructs the camera 16 from for example the input means 32 via the photography instruction means 22 while pointing at a position of the book 12. The shot image data of the book 12 photographed with the camera 16 is transmitted to the position information recognition means 24.

In step S130, the position information recognition means 24 identifies the book 12 by way of the detection signal for the book 12 transmitted from the IC tag sensor 14 as well as recognizes the position pointed at by the user from the shot image data. In this practice, a page of the book 12 may be identified by way of character recognition from the shot image data or based on an input by the user using the input means 32. For example, the user may input voice via a microphone.

With these methods, a page of the book 12 and a predetermined position of the page are recognized and the position information indicating the position in the book 12 is created. The position information created is transmitted to the message information recording means 26.

In step S140, related information on the position in the book 12 specified above is input by the user using the input means. That is, the user inputs, via a keyboard, microphone or scanner, a message to affix to the position in the book 12 or related information used as a reference when reading the book 12 again. The related information may be input from the input means 32 following the photographing session in case the user instructs the camera 16 via the photography instruction means 22. The timing for input of related information is not limited thereto but may be an arbitrary point in time. In such a case, for example, position information created and accumulated on the message information recording means 26 is displayed on the monitor 34 by operating the input means 32. Then the position information where related information is to be affixed is specified and the corresponding related information is input. In any case, what counts in the input of information is that the related information corresponds to the position information.

The related information is input to the message information recording means 26.

The related information is not limited to what the user inputs but may be dealer-provided information affixed to the book 12 provided by the dealer when the book 12 is sold. Information related to the portion of the book 12 may be downloaded from an Internet site and the information acquired may be used as related information.

In this practice, the related information itself may be retained in a separate storage and the access destination, for example the URL of the Internet site alone may be input to the message information means 28.

In step S150, the message information recording means 26 creates message information based on a combination of position information and related information (or address destination of the related information) and records the message information into the memory 28.

In this way, the user can affix related information such as reference information, his/her impressions or notes to any place while reading a book. The content recording medium is not limited to a book. Related information may be affixed to a variety of media such as a notebook, newspaper or photo album.

The message reproducing method is described below.

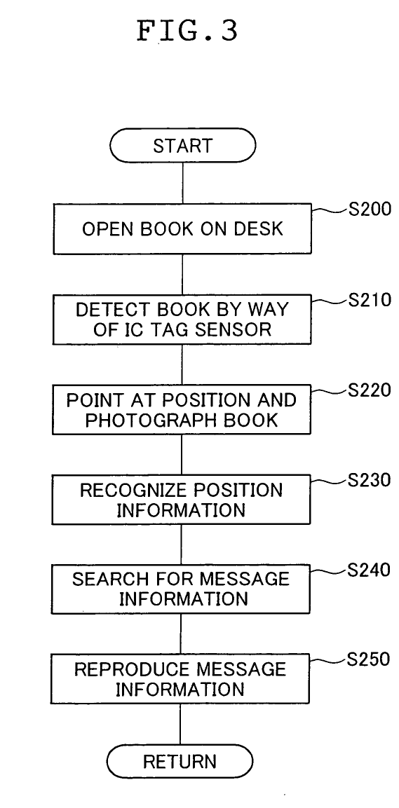

FIG. 3 is a flowchart showing the message reproducing process in a message recording/reproducing system according to this embodiment.

In step S200 in FIG. 3, the system user places the book 12 open having the IC tag 10. In step S210, the IC tag sensor 14 arranged on the desk 42 communicates with the IC tag 10 on the book 12 to detect the book 12. A detection signal is transmitted from the IC tag sensor 14 to the personal computer 20 and input to the photography instruction means 22 and the position information recognition means 24.

Next, in step S220, the system user points at a position on a page of the book 12 and photographs the entire book 12 by using the camera 16 arranged just above the book 12. Photographing may be made when the user points at a position where message information may be affixed and instructs the camera 16 via the photography instruction means 22 to photograph the position. Or, the photographing may be automatically performed in succession at predetermined intervals when the photography instruction means 22 receives the detection signal for the book 12 and the user may point at a predetermined position in the book 12 with the timing of photographing.

The shot image data of the book 12 photographed with the camera 16 is transmitted to the position information recognition means 24.

In step S230, the position information recognition means 24 identifies the book 12 by way of the detection signal for the book 12 transmitted from the IC tag sensor 14 as well as recognizes the position pointed at by the user from the shot image data to thereby create position information.

Next, in step S240, the search means 30 searches the memory 28 to determine whether message information corresponding to the position information is present.

In case the message information corresponding to the position information is found, the search means 30 regenerates the message information in step S250. The message information reproducing methods are not particularly limited. For example, the information may be displayed on the monitor 34 and regenerated via voice from the loudspeaker 35 or output to paper medium from the printer 36, or otherwise regenerated.

In this way, according to this embodiment, it is possible to automatically regenerate related information affixed to a desired position in a content recording medium only by affixing the related information to a desired position in the content recording medium such as a book, notebook, newspaper or photo album while reading or watching the content recording medium and pointing at the appropriate position in the content recording medium when reading/watching the content recording medium again.

Related information may be affixed to a position on a page of a book specified by the user as mentioned in the above, as well as a page of the book, or the book itself.

In case related information is affixed to a page, when the fact that the page of the book is open is recognized from a camera-shot image, the related information on the page is automatically regenerated. In case related information is affixed to a book, when the book is placed on a desk and the book is recognized by the IC tag sensor, the related information on the book is automatically regenerated.

The second embodiment of the invention is described below.

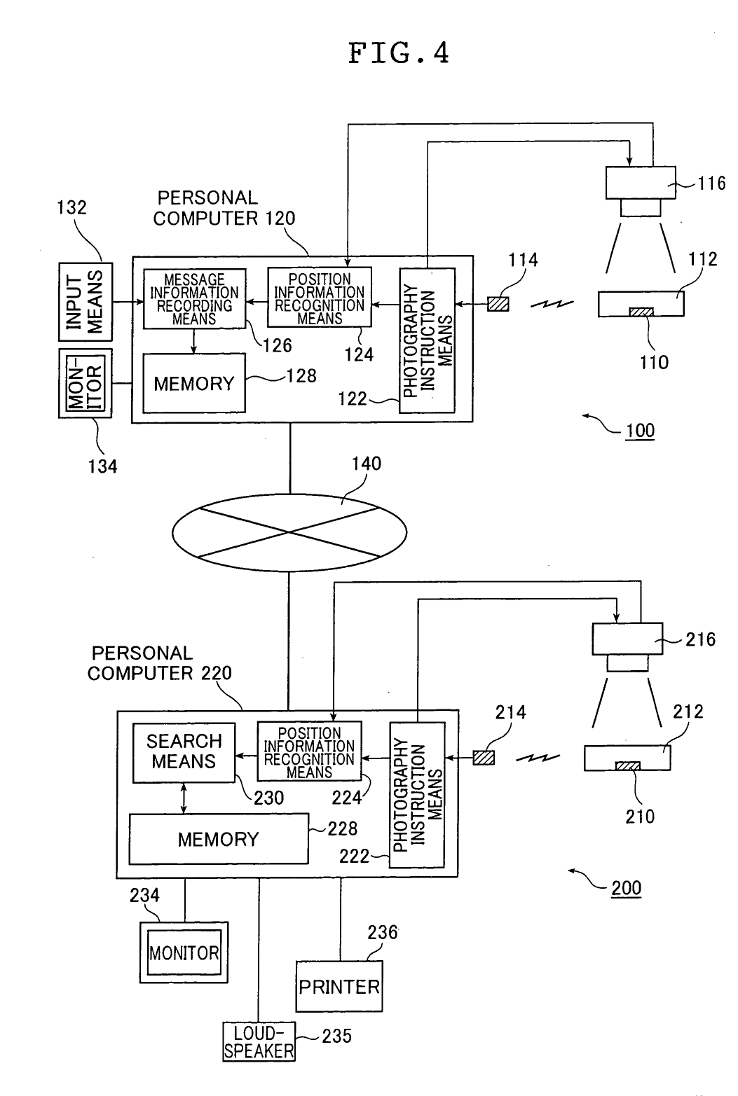

FIG. 4 shows the general configuration of a message recording/reproducing system including a message recording unit and a message reproducing unit according to the second embodiment of the invention.

The message recording/reproducing system according to the second embodiment has a message recording block 100 and a message reproducing block 200 connected with each other by way of a network 140.

The recording block 100 of the message recording/reproducing system shown in FIG. 4 mainly comprises an IC tag sensor 114 for communicating with an IC tag 110 affixed to a content recording medium (book) 112, a camera (digital camera) 116 for photographing the book 112, and a personal computer 120 to which input means 132 and a monitor 134 are connected, the personal computer 120 including photography instruction means 122, position information recognition means 124, message information recording means 126 and a memory 128.

The reproducing block 200 mainly comprises an IC tag sensor 214 for communicating with an IC tag 210 affixed to a content recording medium (book) 212, a camera 216 for photographing the book 212, and a personal computer 220 to which a monitor 234, a loudspeaker 235 and a printer 236 are connected as message reproducing (output) means, the personal computer 220 including photography instruction means 222, position information recognition means 224, a memory 228 and search means 230.

In the foregoing embodiment, at least the components required for message information recording are addressed concerning the message recording block 100 and only the components required for message information reproduction are addressed concerning the message recording block 200. The description is made separately for the message recording block and the message reproducing block only for convenience. The message recording block 100 and the message reproducing block 200 may be incorporated into a single unit which has both functions, same as the first embodiment.

Functions of the above components are the same as those in the first embodiment. The lowest two digits of each component are the same and details thereof are omitted.

The book 112 and the book 212 need to be copies of the same book. They do not need to be a completely same copy of the book in terms of physical point of view, that is, the book 112 in the message recording block transported into the message reproducing block.

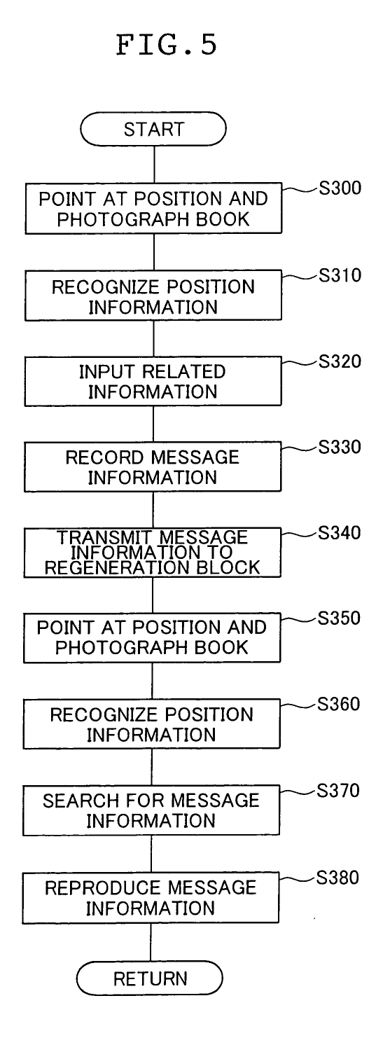

The action of this embodiment is described below referring to flowchart of FIG. 5.

The message information recording method and reproducing method according to this embodiment are basically the same as those in the first embodiment mentioned above. This embodiment is different from the first embodiment in that recording of message information and reproduction of message information are performed by separate units and the message information recorded by the message recording block 100 is transmitted to the message reproducing block 200 for reproduction of the information thereon.

In FIG. 5, the steps S300 through S340 are operations in the message recording block 100 while the steps S350 through S380 are operations in the message reproducing block 200. In the message recording block 100, in step S300, a book 112 is photographed with a camera 116 with a predetermined position in the book 112 specified. In step S310, the position information is recognized from a shot image and position information is created. In step S320, related information corresponding to the position information is input. In step S330, a combination of the position information and the related information is used to create and record message information. The subsequent operation is the same as that in the message recording method shown in FIG. 2 so that the corresponding details are omitted.

Next, in step S340, the message recording block 100 records message information and simultaneously transmits the message information to the message reproducing block 200. The message reproducing block 200 receives the message information and stores the message information into the memory 228.

The message recording block 100 repeats the above operation as often as required to record all message information on the book 112 as well as transmits the message information to the message reproducing block 200 via the network 140 and accumulates the message information into the memory 228 of the message reproducing block 200.

The steps S350 through S380 are operations in the message reproducing block 200. The operation in the message reproducing block 200 is basically the same as that in the message reproducing method in FIG. 3.

To be more specific, in case the system user at the message reproducing block 200 reads the same content recording medium as that of the message recording block 100, for example the same book 212 as the book 112, the system user points at an appropriate position in the book 212 and photographs the position with the camera 216 in step S350. In step S360, the position information on the book 212 is recognized from the shot image. In step S370, the search means 230 searches the memory 228 to determine whether message information corresponding to the position information has been accumulated.

In case the message information corresponding to the position information is detected as a result of the search, the message information is read from the memory 228 and regenerated from message reproducing (output) means such as a monitor 234, loudspeaker 235, or a printer 236.

In case the message information contains an access destination of the related information rather than related information, the search means 230 makes an access to the destination to call and regenerate the related information.

In this way, according to this embodiment, in case related information affixed to a predetermined position of a content recording medium is transmitted to a third party such as a friend of the system user and the third party refers to the same content recording medium, communications with the third party is established using the inventive message recording/reproducing system by regenerating the related information.

While the above embodiment describes a case with a book of the same title, it is possible, in the case of photo prints, to communicate information based on common photographic scenes by affixing an IC tag where common identification information is recorded to each of the additional prints.

The third embodiment of the invention is described blow.

While in the first and second embodiments described above, a camera-shot image is used to point at and recognize a position on the content recording medium, this embodiment simplifies the recognition of the position.

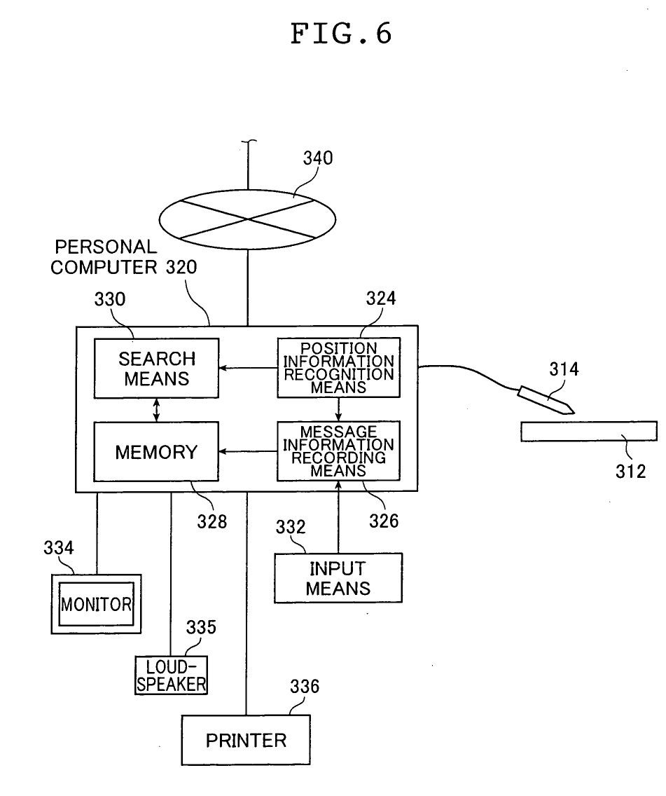

FIG. 6 shows the general configuration of a message recording/reproducing system according to this embodiment.

As shown in FIG. 6, in this embodiment, in order to readily recognize a position on a content recording medium, a sheet 312 where a special dot pattern is formed is used as a content recording medium and the position is detected by pointing at the position while tracing the pattern on the sheet 312 with detection means such as an electronic pen 314 with scanner.

The third embodiment is the same as the first and second embodiments except that the special sheet 312 and the electronic pen 314 are used in order to detect the position.

The position on the content recording medium (sheet 312) detected with the electronic pen 314 is input to position information recognition means 324 of a personal computer 320. The personal computer 320 further comprises message information recording means 326, a memory 328, and search means 330. To the personal computer 320 are connected input means 332 such as a keyboard, a microphone and a scanner and message reproducing means such as a monitor 334, a loudspeaker 335 and a printer 336.

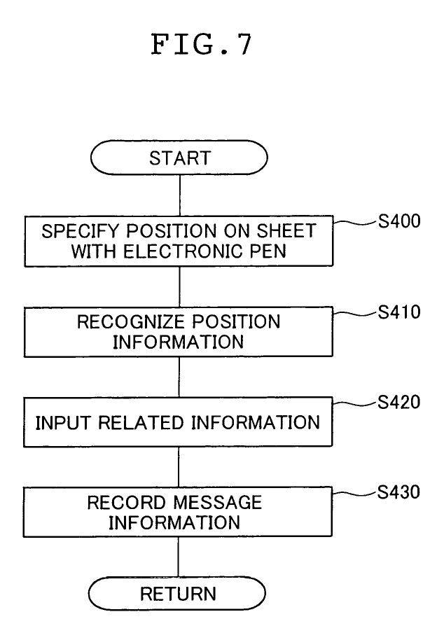

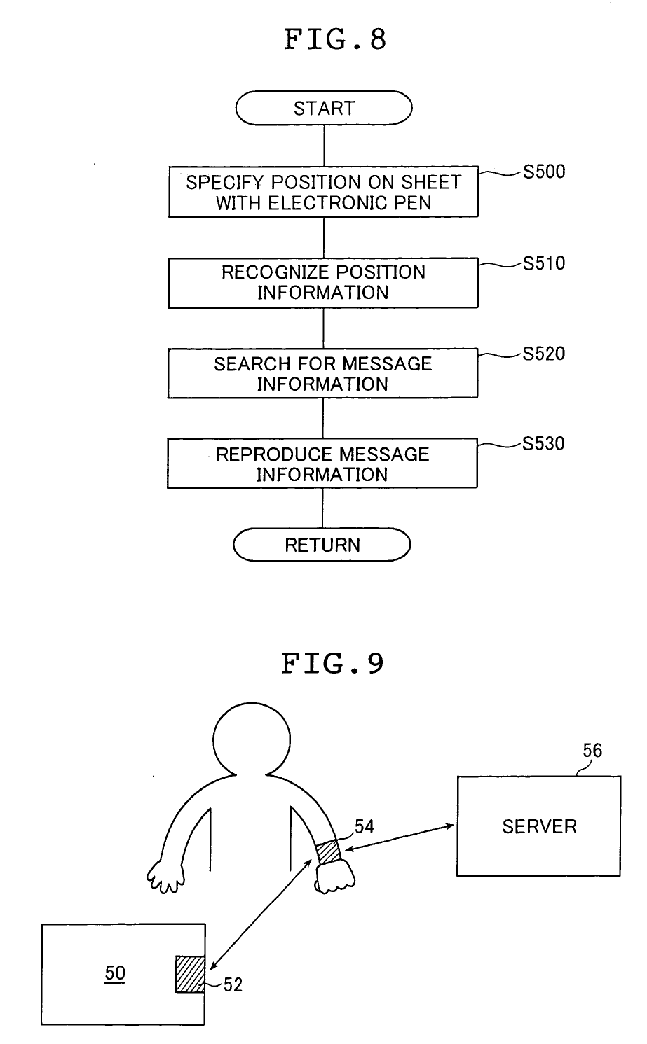

The action of this embodiment is described below referring to FIGS. 7 and 8.

First, the message recording method is described referring to FIG. 7.

In step S400 in FIG. 7, a predetermined position on a content recording medium (for example a book or a notebook using the sheet 312) is specified with an electronic pen (detection means) 314. On the sheet 312 is formed a special dot pattern. By tracing the dot pattern with the electronic pen 314 and reading the special dot pattern, the position on the sheet 312 can be identified.

In step S410, the identified position is input to the position information recognition means 324 of the personal computer 320. The position information recognition means 324 creates position information indicating the predetermined position on the sheet 312 based on the identified position and transmits the position information to the message information recording means 326 and the search means 330.

In step S420, related information corresponding to the position information is input from the input means 332. It is not necessary to input the related information immediately after the position is identified as mentioned earlier, but the related information may be input at an arbitrary point in time as long as the related information corresponds to the position information.

In step S430, the message information recording means 326 creates message information based on a combination of the position information and the related information, and records the resulting message information into the memory 328.

Next, the message reproducing method is described below referring to FIG. 8.

In step S500 in FIG. 8, a predetermined position on the sheet 312 as a content recording medium is specified with an electronic pen 314 as detection means. By specifying the position with the electronic pen 314, the position on the sheet 312 is identified. A signal from the electronic pen 314 is input to the position information recognition means 324 of the personal computer 320.

In step S510, the position information recognition means 324 creates the position information on the sheet 312 from the position identified with the electronic pen 314 and transmits the position information to the search means 330.

In step S520, the search means 330 searches the memory 328 based on the position information received to determine whether message information corresponding to the position information is present.

In case the message information corresponding to the position information is detected as a result of the search, the related information is regenerated on message reproducing means such as a monitor 334 in step S530.

In this way, according to this embodiment, the specified position can be identified by pointing at the position on the sheet 312 with the electronic pen 314 while using as a content recording medium the sheet 312 where a special dot pattern is formed. This makes it possible to identify the position much more easily than the case where a content recording medium is photographed with a camera and the shot image is subjected to image processing and subsequent analysis in order to recognize the position.

While a message recording unit, a message reproducing unit and a message recording/reproducing method according to the invention have been detailed, the invention is not limited to the foregoing embodiments and various changes and modifications can be made in it without departing from the spirit and scope thereof.

Selection may be made between a mode in which only related information is output and a mode in which related information is affixed to the position in the image shot with the camera 16, when information is displayed on a monitor or output to a printer.

A camera in the above embodiments may be a fixed camera or a portable camera (digital camera or camera cell phone). It is not absolutely necessary to point at a predetermined position on a recording medium in order to recognize the position.

Scene identification information may be created for identifying a recording medium or a position on the recording medium by way of image recognition alone without using an IC tag sensor. For example, a front cover title may be photographed and the title may be converted to text data by way of character recognition. Or, the shot image itself may be used as scene identification information. In this case, matching with message information is made by way of pattern matching with the shot image before reproduction of information. In this practice, for example shot images in three stages, the front cover of book, page and pointing with a finger, may be used as shot images. Note that pointing with a finger is not absolutely necessary. Or, an image of a photo print may be used instead.

Alternatively, an IC tag system without a camera may be used. In this case, specification of a page and a position must be made on a separate input unit.

For photo prints, additional prints may be prepared with common identification number affixed to the print margin or print corner. The identification number may be a photographer ID, a date (date and time) and a frame number. In this practice, the identification number may be read using a camera 16 and the data obtained may be subjected to character recognition for recognition of individual prints.

Another application of the invention is a system shown in FIG. 9, where IC tags 52 are affixed to various articles 50 such as a book, a photo and clothes, and when a person who carries a wearable personal computer 54 picks up the article 50, the article ID retained in the IC tag 52 is transmitted to the wearable personal computer 52 via a human body as a conductor and the article 50 is identified. In case the related information on the article 50 is previously recorded in the server 56, a search is made through the server 56 by using the article ID to read the related information on the article. The read information is displayed for example on the display screen of the wearable personal computer 54.

Alternatively, following identification of the article 50, new related information may be recorded into the server 56 from the wearable personal computer 54 in correspondence to the article ID.

Another example is a system where a pressure sensor, an acceleration sensor and a temperature sensor as well as an IC tag 52 are affixed to the article 50, and when a person picks up the article 50, a variation in the detected data from the sensors is used as a trigger to originate an article ID, and the corresponding signal is received on a receiver to identify an article whose data has changed. Or, sensor data may be originated together with the article ID. These signals are originated to the receiver from the IC tag 52. The receiver may be mounted on the wearable personal computer 54 or may be separately provided.

The article 50 may be identified by way of the above approach and information may be written to the IC tag 52 affixed to the article 50 via data transmission or voice recording using a personal computer.

By doing so, it is possible to readily record the related information onto various articles which are not limited to recording media and access the related information.

As mentioned hereinabove, according to the invention, it is readily possible to record message information in a content recorded on various articles, in particular a physical recording medium and regenerate the message information. As a result, it is readily possible to establish communications with a third party via a common physical content recording medium.

The invention is also very convenient in terms of use by the user as well as communications with a third party. For example, a conventional approach is to directly write information in a book or mark the book with a marker pen. This degrades the appearance of the book and correction is difficult once information is directly written. According to the invention, it is possible to overlay previous writing and marking on the page of the book on the monitor. Overwriting and corrections of marking are allowed as often as desired, so that necessary information may be recorded and regenerated without damaging the book.

What is claimed is:

1. A message recording unit comprising:
article identification means for acquiring identification information to identify an individual article;
related information input means for inputting related information related to said individual article; and
message recording means for recording into a storage as a message information said identification information of said individual article and said related information on said individual article in correspondence to each other.

2. A message reproducing unit for regenerating message information recorded into a storage by a message recording unit; said message recording unit comprising:
first article identification means for acquiring identification information to identify an individual article;
related information input means for inputting related information related to said individual article; and
message recording means for recording into said storage as said message information said identification information of said individual article and said related information on said individual article in correspondence to each other,
said message information regenerating unit comprising:
second article identification means for acquiring the identification information to identify the individual article;
search means for searching said storage for said message information corresponding to said identification information; and
message information output means for outputting said message information corresponding to said identification information in case such message information is detected.

3. A message recording unit comprising:
position information acquisition means for acquiring position information to identify a specific position on an individual article;
related information input means for inputting related information related to said specific position on said individual article; and
message information recording means for recording into a storage as message information said position information of said specific position on said individual article and said related information on said specific position on said individual article in correspondence to each other.

4. A message reproducing unit for regenerating message information recorded into a storage by a message recording unit, said message recording unit comprising:
first position information acquisition means for acquiring position information to identify a specific position on an individual article;
related information input means for inputting related information related to said specific position on said individual article; and
message information recording means for recording into said storage as said message information said position information of said specific position on said individual article and said related information on said specific position on said individual article in correspondence to each other,
said message regenerating unit comprising:
second position information acquisition means for acquiring said position information to identify said specific position on said individual article;
search means for searching said storage for said message information corresponding to said position information on said specific position on said individual article; and
message information output means for outputting said message information corresponding to said position information in case such message information is detected.

5. A message recording unit comprising:
photographing means for photographing a content recording medium to which an integrated circuit tag is affixed;
an integrated circuit tag sensor for communicating with said integrated circuit tag affixed to said content recording medium;
photography instruction means for receiving a signal to notice detection of said content recording medium from said integrated circuit tag sensor and instructing said photographing means to photograph said content recording medium whose predetermined position is specified;
position information recognition means for receiving an image of said content recording medium shot by said photographing means and recognizing position information indicating said specified predetermined position in said content recording medium;
related information input means for inputting related information related to said predetermined position in said content recording medium; and
message information recording means for recording as message information a combination of said position information and said related information or an access destination of said related information into a storage.

6. A message recording unit comprising:
detection means for detecting a predetermined position on a surface of a content recording medium on said surface of which a predetermined pattern is formed by specifying said predetermined pattern on said content recording medium;
position information recognition means for recognizing position information from said predetermined position detected by said detection means;
related information input means for inputting related information related to said predetermined position in said content recording medium; and
message information recording means for recording as message information a combination of said position information and said related information or an access destination of said related information into a storage.

7. A message reproducing unit for regenerating message information recorded into a storage by a message recording unit, said message recording unit comprising:
first photographing means for photographing a content recording medium to which an integrated circuit tag is affixed;
a first integrated circuit tag sensor for communicating with said integrated circuit tag affixed to said content recording medium;
first photography instruction means for receiving a signal to notice detection of said content recording medium from said first integrated circuit tag sensor and instructing said first photographing means to photograph said content recording medium whose predetermined position is specified;
first position information recognition means for receiving an image of said content recording medium shot by said first photographing means and recognizing position information indicating said specified predetermined position in said content recording medium;
related information input means for inputting related information related to said predetermined position in said content recording medium; and
message information recording means for recording as said message information a combination of said position information and said related information or an access destination of said related information into said storage,
said message information regenerating unit comprising:
second photographing means for photographing said content recording medium to which said integrated circuit tag is affixed;
a second integrated circuit tag sensor for communicating with said integrated circuit tag affixed to said content recording medium;
second photography instruction means for receiving said signal to notice detection of said content recording medium from said second integrated circuit tag sensor and instructing said second photographing means to photograph said content recording medium;
second position information recognition means for receiving said image of said content recording medium shot by said second photographing means and recognizing said position information on said predetermined position in said content recording medium;
search means for searching said storage for said message information corresponding to said predetermined position in said content recording medium; and
message information output means for outputting said message information corresponding to said predetermined position in said content recording medium in case such message information is detected.

8. A message reproducing unit for regenerating message information recorded into a storage by a message recording unit, said message recording unit comprising:
first detection means for detecting a predetermined position on a surface of a content recording medium on said surface of which a predetermined pattern is formed by specifying said predetermined pattern on said content recording medium;
first position information recognition means for recognizing position information from said predetermined position detected by said first detection means;
related information input means for inputting related information related to said predetermined position in said content recording medium; and
message information recording means for recording as said message information a combination of said position information and said related information or an access destination of said related information into said storage,
said message information regenerating unit comprising:
second detection means for detecting a predetermined position on said content recording on said surface of which said predetermined pattern is formed by specifying a predetermined pattern on said content recording medium;
second position information recognition means for recognizing position information from a predetermined position detected by said second detection means;
search means for searching said storage for said message information corresponding to said predetermined position on said content recording medium; and
message information output means for outputting said message information corresponding to said predetermined position on said content recording medium in case such message information is detected.

9. A message recording/reproducing method, comprising the steps of:
in a side of a message recording unit,
identifying an individual article;
inputting related information corresponding to said identified individual article; and
recording as message information said article and said related information in correspondence to each other into a storage; and thereafter
in a side of a message reproducing unit,
identifying said individual article;
searching said storage for said message information corresponding to said identified individual article;
reading said message information in case said message information is detected; and
outputting said read message information.

10. A message recording/reproducing method, comprising the steps of:
in a side of a message recording unit,
specifying a predetermined position in a content recording medium;
inputting related information corresponding to said predetermined position; and
recording as message information position information indicating said predetermined position and said related information or an access destination of said related information in correspondence to each other in a storage; and thereafter
in a side of a message reproducing unit,
referencing said content recording medium;
searching said storage to determine whether said message information corresponding to said predetermined position on said content recording medium is recorded;
reading said message information in case said corresponding message information is recorded: and
outputting said read message information.

11. A message recording/reproducing method, comprising the steps of:
in a side of a message recording unit,
specifying a predetermined position in a content recording medium;
inputting related information corresponding to said predetermined position; and
providing a message reproducing unit with position information indicating said predetermined position and said related information or an access destination of said related information in correspondence to each other as message information; and thereafter
in a side of a message reproducing unit,
receiving said message information;
accumulating said received message information in a storage;
referencing said content recording medium,
searching said storage to determine whether said message information corresponding to said predetermined position on said content recording medium is accumulated;
reading said message information in case said corresponding message information is accumulated; and
outputting said read message information.
